(19) United States
(12) Patent Application Publication
(10) Pub. No.: US 2012/0063286 A1
(43) Pub. Date: Mar. 15, 2012

(54) OPTICAL PICKUP APPARATUS

(75) Inventors: Chiaki ASAKAWA, Gunma (JP); Mitsuhiro Hiruma, Kiryu-shi (JP)

(73) Assignee: SANYO Electric Co., Ltd., Moriguchi-shi (JP)

(21) Appl. No.: 13/232,701

(22) Filed: Sep. 14, 2011

(30) Foreign Application Priority Data
Sep. 14, 2010 (JP) 2010-205772

(51) Int. Cl. G11B 7/16; G11B 7/135

(52) U.S. Cl. 369/112.22; 369/112.23; G9B/7.112; G9B/7.124

(57) ABSTRACT

A conventional optical pickup apparatus has a problem that due to multiple optical paths provided therein, the number of parts of optical systems becomes larger and a time required for attaching the parts and adjusting an optical axis becomes longer. In optical pickup apparatus 1 of the invention, a major part of optical path 21 of a laser beam emitted from first semiconductor laser device 2 and optical path 20 of a laser beam emitted from second semiconductor laser device 3 are shared. Then, the laser beam reflected from the optical disk 17 (optical feedback) is received by shared PDIC 19 and light-receiving processing is accurately performed on the laser beam as a light detector. With this structure, the number of parts of optical systems disposed in the optical pickup apparatus 1 is reduced, an attachment operation of the parts becomes easier, and a time required for adjusting an optical axis is reduced. Thus, an operational efficiency is greatly improved.

This application claims priority from Japanese Patent Application Number JP 2010-205772 filed on Sep. 14, 2010, the content of which is incorporated herein by reference in its entirety.

### BACKGROUND OF THE INVENTION

1. Field of the Invention

The present invention relates to an optical pickup apparatus which performs recording and/or reproduction by using light with multiple kinds of wavelengths.

2. Description of the Related Art

A structure shown in FIGS. 3A and 3B has been known as an embodiment of a conventional optical pickup apparatus. Note that FIG. 3A shows a side view of an optical system of the optical pickup apparatus, while FIG. 3B shows a plan view of the optical system of the optical pickup apparatus.

As shown in the drawings, an optical pickup apparatus 31 includes first and second light sources 32A and 32B configured to emit light beams, and first and second optical systems 34A and 34B configured to guide the emitted light beams to an optical disk 42 and to guide light beams reflected from the optical disk 42 to first and second light-receiving elements (PDIC) 33A and 33B.

Specifically, the first light source 32A emits light beams for CD and DVD, while the second light source 32B emits a light beam for BD. The light beams respectively emitted from the first and second light sources 32A and 32B respectively travel on optical paths of the first and second optical systems 34A and 34B. The first and second optical systems 34A and 34B include first and second polarization beam splitters 35A and 35B, first and second collimator lenses 36A and 36B, a reflecting mirror 37, first and second quarter wavelength plates 38A and 38B, first and second objective lenses 39A and 39B, first and second HOE (Holographic Optical Element) 40A and 40B, first and second PDIC 33A and 33B, first and second front monitor diodes 41A and 41B, and the like (This technology is described, for instance, in Japanese Patent Application Publication No. 2009-32304, on pages 7 to 9 and FIGS. 1 and 2).

As described above, in the conventional optical pickup apparatus 31, the light beam emitted from the first light source 32A passes through the optical path of the first optical system 34A and enters the optical disk 42. The light beam reflected by the optical disk 42 similarly passes through the optical path of the first optical system 34A and enters the first PDIC 33A. On the other hand, the light beam emitted from the second light source 32B passes through the optical path of the second optical system 34B and enters the optical disk 42. Similarly, the light beam reflected by the optical disk 42 passes through the optical path of the second optical system 34B and enters the second PDIC 33B.

That is to say, since the optical path of the first optical system 34A is different from the optical path of the second optical system 34B, the number of parts of the optical systems disposed inside the optical pickup apparatus 31 becomes larger. This causes a problem that a longer time is required for attaching the parts or adjusting optical axes. Also, since the optical systems 34A and 34B have different optical paths, parts of the optical systems are required for each of the optical systems 34A and 34B. Moreover, space for the optical paths has to be secured. This causes a problem that it is difficult to reduce the optical pickup apparatus 31 in size.

### SUMMARY OF THE INVENTION

The present invention has been made in view of the foregoing problem. Accordingly, an object of the invention is to provide an optical pickup apparatus that includes a first emitting element configured to emit a first laser beam having a first wavelength; a second emitting element configured to emit a second laser beam having a second wavelength different from the first wavelength; a light-receiving element; an objective lens system; and an optical element, in which a first optical path for the first laser beam and a second optical path for the second laser beam are formed between the light-receiving element and the objective lens system so that the first and second emitting elements and the optical element are disposed in the first and second optical paths, the first and second optical paths having a shared optical path, the optical element is configured to cause the second laser beam returning from the objective lens system to partially leak from the second optical path, and the first laser beam and the second laser beam are received by the light-receiving element.

### BRIEF DESCRIPTION OF THE DRAWINGS

FIG. 1 is a schematic diagram illustrating an optical system of an optical pickup apparatus according to an embodiment of the invention.

FIG. 2A is a schematic diagram illustrating an optical system of the optical pickup apparatus according to the embodiment of the invention, and FIG. 2B is a table illustrating a characteristic of a reflection film which is used in the optical pickup apparatus according to the embodiment of the invention.

FIGS. 3A and 3B are schematic diagrams illustrating an optical system of an optical pickup apparatus according to a conventional embodiment.

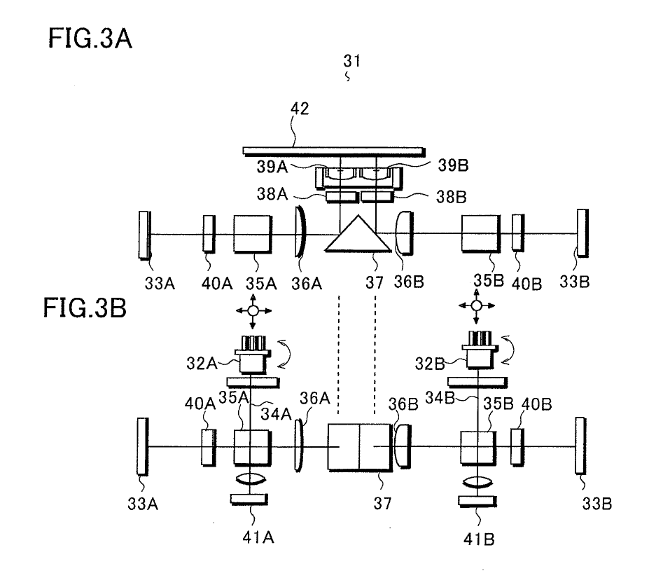

### DESCRIPTION OF THE INVENTION

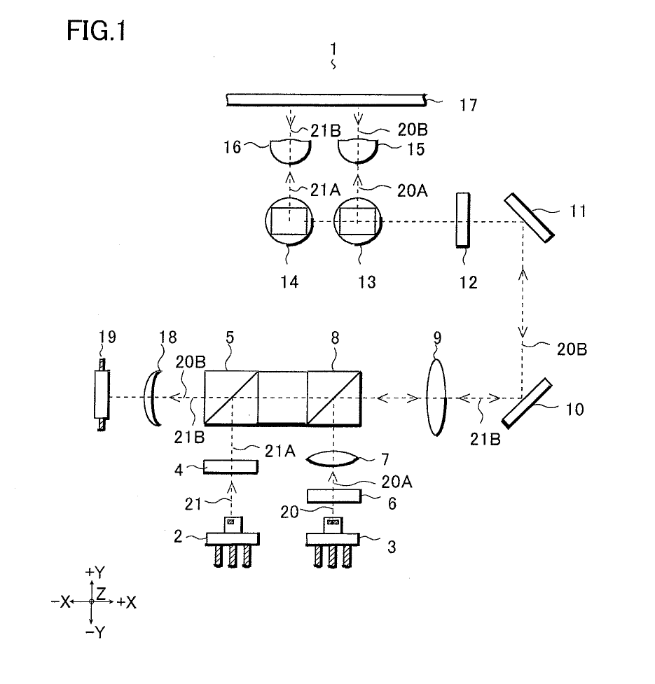

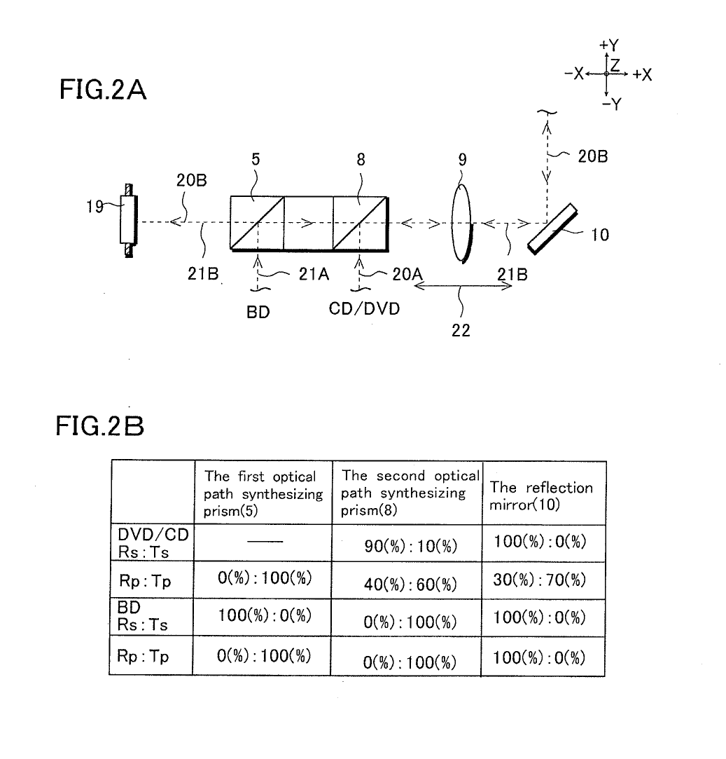

Hereinafter, an optical pickup apparatus according to a preferred embodiment of the invention is described. FIG. 1 is a schematic diagram illustrating an optical system of the optical pickup apparatus. FIG. 2A is a schematic diagram illustrating the arrangement of parts of an optical system of the optical pickup apparatus. FIG. 2B is a table illustrating a characteristic of a reflection film which is used in the optical pickup apparatus.

As shown in FIG. 1, an optical pickup apparatus 1 includes functions to focus laser beams of a BD (Blu-ray Disc) standard, a DVD (Digital Versatile Disk) standard, or a CD (Compact Disk) standard onto an information recording layer of an optical disk (an optical information recording medium), to receive the light reflected from the information recording layer, and to convert the received light to electric signals.

A first semiconductor laser device 2 emits a laser beam with a BD-standard wavelength (a blue-violet (blue) wavelength range of 400 nm to 420 nm (e.g., 405 nm)). A second semiconductor laser device 3 emits a laser beam with a DVD-standard wavelength (a red wavelength range of 645 nm to 675 nm (e.g., 655 nm)) and a laser beam with a CD-standard wavelength (an infrared wavelength range of 765 nm to 805 nm (e.g., 785 nm)). Note that the first and second semiconductor laser devices 2 and 3 may be a CAN-type package or a lead-frame-type package.

A first diffraction grating 4 is disposed between the first semiconductor laser device 2 and a first optical path synthesizing prism 5 to receive the laser beam of the BD standard. The first diffraction grating 4 includes a diffraction grating configured to decompose the entering laser beam into a 0-th order light, a +1 order diffracted light, and a −1 order diffracted light, and a half wavelength plate configured to convert the entering laser beam to a linearly polarized light in the S direction with respect to a polarization surface of the first optical path synthesizing prism 5. Similarly, a second diffraction grating 6 is disposed between the second semiconductor laser device 3 and a second optical path synthesizing prism 8 and includes a diffraction grating and a half wavelength plate. Note that the second diffraction grating 6 converts the entering light beams of the DVD standard and the CD standard to linearly polarized light in the S direction with respect to the polarization surface of the second optical path synthesizing prism 8.

A divergent lens 7 is disposed between the second diffraction grating 6 and the second optical path synthesizing prism 8 and is configured to adjust an angle of divergence of the laser beam diffracted by the second diffraction grating 6.

The first optical path synthesizing prism 5 has a built-in polarization surface having a wavelength selectivity and a polarization selectivity, and functions as a polarization beam splitter for the laser beam of the BD standard and functions as a total transmitting prism for the laser beams of the DVD standard and the CD standard. Specifically, for example, a reflection film to be described later is formed on the polarization surface, so that the laser beam of the BD standard, which is a linearly polarized light in the S direction, is reflected by the polarization surface in the +X direction indicated on the sheet. On the other hand, the laser beam of the BD standard, which is reflected by an optical disk 17 (optical feedback), passes through a quarter wavelength plate 12 to be a linearly polarized light in the P direction, thereby being transmitted through the polarization surface in the −X direction indicated on the sheet. Note that the laser beams of the DVD standard and the CD standard which enter the first optical path synthesizing prism 5 are totally transmitted through this reflection film in the ±X directions on the sheet.

The second optical path synthesizing prism 8 has a built-in polarization surface having a wavelength selectivity and a polarization selectivity, and functions as a polarization beam splitter for the laser beams of the DVD standard and the CD standard and functions as a total transmitting prism for the laser beam of the BD standard. Specifically, the second optical path synthesizing prism 8 adjusts a reflectivity of the laser beams of the DVD standard and the CD standard to adjust a quantity of light of a second laser beam which is guided to the PDIC 19. Then, for example, a reflection film to be described later is formed on the polarization surface, so that a major part of the laser beams of the DVD standard and the CD standard, which are a linearly polarized light in the S direction, are reflected by the polarization surface in the +X direction indicated on the sheet. On the other hand, the laser beams of the DVD standard and the CD standard, which are reflected by the optical disk (optical feedback), is caused to become a linearly polarized light in the P direction by passing through the quarter wavelength plate 12 and is transmitted through this polarization surface by a certain percentage in the −X direction indicated on the sheet. Note that the laser beam of the BD standard, which enters the second optical path synthesizing prism 8, is transmitted through this polarization surface in the ±X directions indicated on the sheet.

A collimate lens 9 converts the laser beams of the BD standard, the DVD standard, and the CD standard into parallel beams. As shown in the drawings, the optical pickup apparatus 1 supports three-types of laser beams by using one collimate lens 9. The collimate lens 9 moves in a direction (the ±X directions indicated on the sheet) parallel to the optical path (optical axis) shown by a dashed line. Then, the collimate lens 9 optimizes an optical magnification according to a laser beam of the standard of each medium, so that interlayer stray light or interlayer crosstalk is suppressed to be caused.

The first reflection mirror 10 has a wavelength selectivity and a polarization selectivity. Specifically, for example, a reflection film to be described later is formed on the first reflection mirror 10, so that the first reflection mirror 10 adjusts the reflectivity of the laser beams of the DVD standard and the CD standard to adjust a quantity of light of the second laser beam which is guided to the second optical path synthesizing prism 8. Then, the laser beams of the DVD standard and the CD standard, which are reflected by the optical disk 17 (optical feedback), are partially reflected in the −X direction indicated on the sheet according to the characteristic of the reflection film and a rest thereof is transmitted in the −Y direction indicated on the sheet. Note that the laser beam of the BD standard is totally reflected in the Y direction or the −X direction indicated on the sheet.

A second reflection mirror 11 totally reflects the laser beams of the BD standard, the DVD standard, and the CD standard in the −X direction indicated on the sheet. On the other hand, the laser beams reflected by the optical disk 17 (optical feedback) are also totally reflected in the −Y direction indicated on the sheet.

Note that in the following, the description is given of the case where a reflection film is formed on the first reflection mirror 10 and the reflectivity of the laser beams of the DVD standard and the CD standard is adjusted by the second optical path synthesizing prism 8 and the first reflection mirror 10 to adjust the quantity of light which is guided to the PDIC 19. However, the embodiment is not limited to this case. For example, it is also possible that by reversely using the rolls of the first and second reflection mirrors 10 and 11, the second optical path synthesizing prism 8 and the second reflection mirror 11 adjust the reflectivity of the laser beams of the DVD standard and the CD standard to adjust the quantity of light thereof to be guided to the PDIC 19.

The quarter wavelength plate 12 causes a phase difference in the entering laser beam. Thus, the laser beams of the BD standard, the DVD standard, and the CD standard are converted from the linearly polarized light in the S direction to a circularly polarized light. On the other hand, the laser beams reflected by the optical disk (optical feedback) are converted to linearly polarized light in the P direction after passing through the quarter wavelength plate 12 again.

A second reflecting mirror 13 includes a reflection surface having a wavelength selectivity and reflects the laser beams of the DVD standard and the CD standard in the +Y direction indicated on the sheet, and the laser beam of the BD standard is transmitted through the second reflecting mirror 13 in the −X direction indicated on the sheet. On the other hand, a first reflecting mirror 14 reflects the laser beam of the BD standard, which has been transmitted through the second reflecting mirror 13, in the +Y direction indicated on the sheet.

A second objective lens 15 focuses the laser beams of the DVD standard and the CD standard, which is reflected by the second reflecting mirror 13, onto the information recording layer of the optical disk 17. Similarly, a first objective lens 16 focuses the laser beam of the BD standard, which is reflected by the first reflecting mirror 14, onto the information recording layer of the optical disk 17.

An astigmatism generating element 18, for example, an anamorphic lens, is disposed between the first optical path synthesizing prism 5 and the PDIC 19. The three-types of laser beams reflected by the optical disk 17 (optical feedback) pass through the astigmatism generating element 18. Then, the astigmatism generating element 18 gives an aberration for focus servo to the passing laser beams. Accordingly, the one PDIC 19 can process the three-types of laser beams having different wavelengths.

The PDIC 19 functions as a light detector having a built-in photodiode integrated circuit element for detecting a signal, and receives the laser beam of the BD standard, the DVD standard, or the CD standard in a same light-receiving region on the same plane and outputs a detection signal containing an information signal component through photoelectric conversion. Furthermore, the PDIC 19 outputs a detection signal containing a servo signal component which is used for focus servo and tracking servo.

The optical path 20 of the laser beams of the DVD standard and the CD standard is described below.

The laser beam emitted from the second semiconductor laser device 3 is converted to a linearly polarized light in the S direction by the second diffraction grating 6 and is adjusted to a desired angle of divergence by divergent lens 7 and thereafter enters the second optical path synthesizing prism 8. Then, the laser beam is reflected by a desired quantity of light by a polarization surface of the second optical path synthesizing prism 8 and is totally reflected by the first reflection mirror 10.

Thereafter, the laser beam is totally reflected by the second reflection mirror 11 to pass through the quarter wavelength plate 12, to be converted from the linearly polarized light in the S direction to a circularly polarized light. After that, the circularly polarized laser beam is reflected by the second reflecting mirror 13 and thereafter is focused onto the information recording layer of the optical disk 17 by the second objective lens 15. Note that this optical path serves the role as an outgoing path 20A for the laser beams of the DVD standard and the CD standard.

The laser beam reflected by the information recording layer of the optical disk 17 (optical feedback) is transmitted through the second objective lens 15, is reflected by the second reflecting mirror 13, and thereafter is transmitted through the quarter wavelength plate 12. Accordingly, the laser beam is converted from the circularly polarized light to the linearly polarized light in the P direction. After that, the laser beam is reflected by the first and second reflection mirrors 10 and 11, and thereafter is transmitted through the collimate lens 9, the second optical path synthesizing prism 8, and the first optical path synthesizing prism 5. Then, the astigmatism generating element 18 gives an aberration to the laser beam. The laser beam then enters the PDIC 19, is received by a light-receiving region of the PDIC 19, and is thus converted into a detection signal through photoelectric conversion. Note that this optical path serves the roll as an incoming path 20B for the laser beams of the DVD standard and the CD standard. The reflectivity of the laser beams of the DVD standard and the CD standard is adjusted by the second optical path synthesizing prism 8 and the first reflection mirror 10 to adjust the quantity of light of the laser beams of the DVD standard and the CD standard, which enter the PDIC 19.

Hereinafter, an optical path 21 of the laser beam of the BD standard is described.

The laser beam emitted from the first semiconductor laser device 2 is converted to a linearly polarized light in the S direction by the first diffraction grating 4 and then enters the first optical path synthesizing prism 5. After that, the laser beam is totally reflected by the polarization surface of the first optical path synthesizing prism 5 and, thereafter, is totally transmitted through the second optical path synthesizing prism 8. Then, the laser beam is is totally reflected by the first and second reflection mirrors 10 and 11, and thereafter passes through the quarter wavelength plate 12. Accordingly, the laser beam is converted from the linearly polarized light in the S direction to a circularly polarized light. The laser beam of the circularly polarized light is transmitted through the second reflecting mirror 13, is reflected by the first reflecting mirror 14, and thereafter is focused onto the information recording layer of the optical disk 17 by the first objective lens 16. Note that this optical path serves as an outgoing path 21A of the laser beam of the BD standard.

The laser beam reflected by the information recording layer of the optical disk 17 (optical feedback) is transmitted through the first objective lens 16, is transmitted through the second reflecting mirror 13 and the quarter wavelength plate 12, and is then reflected by the first reflecting mirror 14. Accordingly, the laser beam is converted from the circularly polarized light to the linearly polarized light in the P direction. Then, after being totally reflected by the first and second reflection mirrors 10 and 11, the laser beam is sequentially transmitted through the collimate lens 9, the second optical path synthesizing prism 8, and the first optical path synthesizing prism 5. Thereafter, the laser beam is given of an aberration by the astigmatism generating element 18 and enters the PDIC 19 and is received by the light-receiving region of the PDIC 19, so that a detection signal is output through photoelectric conversion. Note that this optical path serves as an incoming path 21B of the laser beam of the BD standard.

As described above, in the optical pickup apparatus 1, a major part of the optical path 20 of the laser beams of the DVD standard and the CD standard and the optical path 21 of the laser beam of the BD standard is shared. The collimate lens 9, the reflection mirrors 10 and 11, the quarter wavelength plate 12, and the PDIC 19 which are disposed on the optical paths 20 and 21 are used as parts shared between the optical paths 20 and 21. As a result, the number of parts of the optical systems disposed in the optical pickup apparatus 1 is reduced, and the attachment operation of the parts becomes easier. Also, a time required for adjusting an optical axis is reduced. Furthermore, the optical path 20 of the laser beams of the DVD standard and the CD standard and the optical path 21 of the laser beam of the BD standard are shared, so that the miniaturization of the optical pickup apparatus 1 can be achieved.

As shown in FIG. 2A, the optical path 20 of the laser beams of the DVD standard and the CD standard and the optical path 21 of the laser beam of the BD standard are shared, so that the second optical path synthesizing prism 8 is disposed on the optical path 21 of the laser beam of the BD standard. Therefore, the laser beam of the BD standard is transmitted through the polarization surface of the second optical path synthesizing prism 8 even in the outgoing path 21A and an incoming path 21B. For this reason, the characteristic of the reflection film which is used for the second optical path synthesizing prism 8 is determined based on a desired reflectivity and transmittivity with respect to the laser beams of the DVD standard and the CD standard and is also determined so that the laser beam of the BD standard totally is transmitted through the reflection film.

On the other hand, in particular, the laser beams of the DVD standard and the CD standard are easily affected in the optical disk 17, and there is a case where the laser beams of the DVD standard and the CD standard do not become a laser beam of a linearly polarized light in the P direction on the incoming path 20B due to a birefringence of the optical disk 17 with bad quality, but becomes a laser beam of a linearly polarized light in the S direction. Then, even when the laser beam reflected from the optical disk 17 becomes a laser beam of a linearly polarized light in the S direction, it is necessary that the laser beam is received by the PDIC 19 and a detection signal is outputted.

In this regard, as shown in FIG. 2B, a reflection film having a wavelength selectivity and a polarized selectively is formed on each of the first and second optical path synthesizing prisms 5 and 8, and the first reflection mirror 10. Specifically, formed on the first optical path synthesizing prism 5 is a reflection film which totally transmits the laser beams of the DVD standard and the CD standard and totally reflects the linearly polarized light in the S direction of the laser beam of the BD standard while transmitting the linearly polarized light in the P direction of the laser beam of the BD standard.

Also, formed on the second optical path synthesizing prism 8 is a reflection film which totally transmits the laser beam of the BD standard, and reflects 90% of the linearly polarized light in the S direction of the laser beams of the DVD standard and the CD standard while transmitting 60% of the linearly polarized light in the P direction of the laser beams of the DVD standard and the CD standard. Here, as described above, if the optical disk 17 has a bad quality and the laser beam of the linearly polarized light in the S direction returns on the incoming path 20B, 10% of the laser beams of the DVD standard and the CD standard is transmitted through the second optical path synthesizing prism 8. This causes a problem that a large difference is generated relative to the quantity of transmitted light in the case of the linearly polarized light in the P direction.

In this regard, formed on the first reflection mirror 10 is a reflection film which totally reflects the laser beam of the BD standard, and reflects 100% of the linearly polarized light in the S direction of the laser beams of the DVD standard and the CD standard while reflecting 30% of the linearly polarized light in the P direction of the laser beams of the DVD standard and the CD standard. If the laser beams of the DVD standard and the CD standard of the linearly polarized light in the P direction return on the incoming path 20B, 30% of the laser beam is reflected by the first reflection mirror 10 and 60% of the laser beam is transmitted through the second optical path synthesizing prism 8, and, thus, 18% of the linearly polarized light in the P direction is transmitted through the second optical path synthesizing prism 8. As a result, with regard to the laser beams of the DVD standard and the CD standard, the reflectivity (18%) of the linearly polarized light in the P direction and the reflectivity (10%) of the linearly polarized light in the S direction approximate to each other on the incoming path 20B. If the PDIC 19 receives the laser beam of the linearly polarized light in the P direction, or even if the PDIC 19 receives the laser beam of the linearly polarized light in the S direction, there is no big difference in the quantities of light thereof, thereby being capable of correctly outputting a detecting signal as a light detector.

Furthermore, since the first optical path synthesizing prism 5 is disposed to be closer to the PDIC 19 side than the second optical path synthesizing prism 8, a length of the optical path of the laser beam of the BD standard becomes longer than a length of the optical path of the laser beams of the DVD standard and the CD standard. For example, if the first and second optical path synthesizing prisms 5 and 8 are integrally formed, the longitudinal direction of the integrated prisms is disposed along the optical paths 20 and 21 shown by the dotted line, so that the relationship in the lengths of the optical paths can be achieved. The laser beam of the BD standard has a shorter wavelength as compared with the wavelength of the laser beams of the DVD standard and the CD standard. Also, the structure of an optical disk of the BD standard is different from the structure of optical disks of the DVD standard and the CD standard. Thus, the laser beam of the BD standard is easily affected by an aberration as compared with the laser beams of the DVD standard and the CD standard. Accordingly, as shown by the arrowed line 22, it becomes important that the collimate lens 9 secures a distance to travel in a parallel direction (the ±X directions indicated on the sheet) with respect to the optical path (optical axis) shown by the dotted line. In other words, the length of the optical path of the laser beam of the BD standard is secured by using the arrangement of the first and second optical path synthesizing prisms 5 and 8. Accordingly, the miniaturization of the device size and an optical pickup apparatus supporting three wavelengths can be achieved.

Note that in the embodiment, the description is given of the case where design conditions such as an incident angle of a laser beam, a quality, material, and thickness of a reflection film, and the like are taken into consideration, and a reflectivity of laser beams of the DVD standard and the CD standard is adjusted by a reflection film which is formed on the second optical path synthesizing prism 8 and the first reflection mirror 10 to adjust a quantity of light to be guided to the PDIC 19. However, the embodiment is not limited to this case. For example, such case can be thought that the reflectivity of the laser beams of the DVD standard and the CD standard is adjusted only by the reflection film which is formed on the polarization surface of the second optical path synthesizing prism 8, so that the transmittivity of the linearly polarized light in the P direction of the laser beams of the DVD standard and the CD standard is caused to be proximate to the transmittivity of the linearly polarized light in the S direction, and, thus, the quantity of the light received by the PDIC 19 is adjusted. Also, with regard to the characteristic of the reflection film shown in FIG. 2B, a numerical value thereof can be changed as needed according to the design conditions such as an incident angle of the laser beam, a quality, material, thickness of the reflection film, and the like.

Also, as shown in FIG. 2A, the description is given of the case where the first and second optical path prisms 5 and 8 are integrally formed. However, the embodiment is not limited to this case. For example, the first and second optical path synthesizing prisms 5 and 8 may be separated parts. Also, the first and second optical path synthesizing prisms 5 and 8 may be replaced by a reflection mirror on which the reflection film is formed.

Also the description is given of the case where a reflection film which partially transmits the laser beams of the DVD standard and the CD standard is formed on the reflection mirror 10, so that the reflectivity and transmittivity of the laser beams are adjusted. However the embodiment is not limited to this case. For example, with the structure in which the laser beams of the DVD standard and the CD standard, which enters the reflection mirror 10, partially leaks from the reflection mirror 10, it is only needed that the one portion of the laser beam at least travels off the optical path and the reflectivity and transmittivity of the laser beam are adjusted. Moreover, various modifications can be made in a range without departing from the scope of the invention.

According to the invention, the second laser beam partially leaks from the optical path by the optical element, so that a ratio of the quantity of light of the first laser beam to the quantity of light of the second laser beam, which are reflected from an optical information recording medium, is adjusted to be a desired ratio. With this structure, the first and second laser beams can be received by a shared light-receiving element, the number of parts of the optical systems disposed in the optical pickup apparatus is reduced, and the attachment operation of the parts becomes easier.

According to the invention, the reflection film which adjusts a ratio of the quantity of light of the second laser beam is formed on the reflection mirror disposed in a region shared between the first optical path and the second optical path.

Also, according to the invention, the first and second optical paths are partially shared, so that a time required for adjusting an optical axis is reduced and the miniaturization of the optical pickup apparatus can be achieved.

Furthermore, according to the invention, a reflectivity and a transmittivity of the second laser beam are adjusted by the second optical path synthesizing prism and the reflection mirror. Thus, it can be achieved that the optical paths can be partially shared.

Also, according to the invention, a length of the optical path of a laser beam of the BD standard is set longer than a length of the optical path of laser beams of the DVD standard and the CD standard. Thus, an aberration of the laser beam of the BD standard is accurately adjusted.

What is claimed is:

1. An optical pickup apparatus comprising:
a first emitting element configured to emit a first laser beam having a first wavelength;
a second emitting element configured to emit a second laser beam having a second wavelength different from the first wavelength;
a light-receiving element;
an objective lens system; and
an optical element,
wherein a first optical path for the first laser beam and a second optical path for the second laser beam are formed between the light-receiving element and the objective lens system so that the first and second emitting elements and the optical element are disposed in the first and second optical paths, the first and second optical paths having a shared optical path,
the optical element is configured to cause the second laser beam returning from the objective lens system to partially leak from the second optical path, and
the first laser beam and the second laser beam are received by the light-receiving element.

2. The optical pickup apparatus of claim 1, wherein the optical element comprising a reflection mirror disposed in the shared optical path and a reflection film disposed on the reflection mirror so that a predetermined reduced amount of the second laser beam entering the optical element from the objective lens system is lead to the light-receiving element.

3. The optical pickup apparatus of claim 2, wherein the reflection mirror is configured to reflect totally the second laser beam coming from the second emitting element and to reflect only partially the second laser beam returning from the objective lens system.

4. The optical pickup apparatus of claim 2, further comprising a first optical path synthesizing prism reflecting or transmitting the first laser beam, a second optical path synthesizing prism reflecting or transmitting the second laser beam, and another reflection film disposed on the second optical path synthesizing prism, wherein the first and second optical path synthesizing prisms, the reflection mirror and the light-receiving element are in the shared optical path, the first optical path synthesizing prism is disposed closer to the light-receiving element than the second optical path synthesizing prism, and the amount of the second laser beam lead to the light-receiving element is determined by the reflection film and the another reflection film.

5. The optical pickup apparatus of claim 1, wherein the first laser beam comprises a laser beam of a BD standard, and the second laser beam comprises a laser beam of a DVD or CD standard.
